(19) United States
(12) Patent Application Publication
(10) Pub. No.: US 2024/0403069 A1
(43) Pub. Date: Dec. 5, 2024

(54) SERVICE PROCESSING METHODS AND APPARATUSES

(71) Applicants: Chongqing BOE Intelligent Technology Co., Ltd., Chongqing (CN); BOE Technology Group Co., Ltd., Beijing (CN)

(72) Inventors: Yun YANG, Beijing (CN); Xiaoqin GUO, Beijing (CN)

(21) Appl. No.: 18/698,001

(22) PCT Filed: Jan. 3, 2023
(86) PCT No.: PCT/CN2023/070144

§ 371 Date: Apr. 2, 2024

(30) Foreign Application Priority Data
Feb. 25, 2022 (CN) 202210179845.6

(51) Int. Cl. G06F 9/445; G06F 9/52; G06F 9/54

(52) U.S. Cl. CPC G06F 9/44505; G06F 9/52; G06F 9/544

(57) ABSTRACT

The present disclosure provides service processing methods and apparatuses. The method includes: in response to receiving a to-be-processed service request, creating a shared memory region, and determining a startup parameter, where the startup parameter includes information of the shared memory region; conveying the startup parameter to a second process such that the second process is started up based on the startup parameter; where the second process indicates a functional module used to implement the to-be-processed service request; based on the to-be-processed service request, generating a first processing command; writing the first processing command into the shared memory region such that the second process reads the first processing command from the shared memory region based on the information of the shared memory region, and performs a processing operation based on the first processing command.

### TECHNICAL FIELD

The present disclosure relates to the technical field of electronic devices and in particular to service processing methods and apparatuses.

### BACKGROUND

As program scale increases, higher requirements for program stability are proposed. To enable a program to implement a particular service function, it is usually required to, during program development, integrate a component of a third-party company into the program. Since the component is provided by the third-party company, it has poor stability, and hence, a process corresponding to the program in which the component is integrated may crash during running.

Nowadays, to ensure the normal operation of the program, a design mode of “watchdog” may be employed, namely, when service processing is performed using the program, if it is detected that the process corresponding to the program stops running, the process will be recovered immediately. But, this design mode is considered only for the purpose of maintenance rather than for ensuring program stability at a deeper level.

### SUMMARY

To overcome the problems in the related arts, the present disclosure provides service processing methods and apparatuses.

According to a first aspect of embodiments of the present disclosure, there is provided a service processing method, which is applied to an electronic device configured to perform a first process. The method includes:
in response to receiving a to-be-processed service request, creating a shared memory region, and determining a startup parameter, where the startup parameter includes information of the shared memory region;
conveying the startup parameter to a second process such that the second process is started up based on the startup parameter; where the second process indicates a functional module used to implement the to-be-processed service request;
based on the to-be-processed service request, generating a first processing command;
writing the first processing command into the shared memory region such that the second process reads the first processing command from the shared memory region based on the information of the shared memory, and performs a processing operation based on the first processing command.

In some embodiments, the second process indicates a third-party component; the shared memory region includes a first shared memory region and a second shared memory region; the first shared memory region is configured to store data written by the first process, and the second shared memory region is configured to store data to be read by the first process;
writing the first processing command into the shared memory region includes:
writing the first processing command into the first shared memory region such that the second process reads the first processing command from the first shared memory region, performs a corresponding processing operation based on the first processing command to obtain a first processing result, and writes the first processing result into the second shared memory region;
the method further includes:
reading the first processing result from the second shared memory region and based on the first processing result, performing a corresponding processing operation.

In some embodiments, the first shared memory region corresponds to a first read semaphore and a first write semaphore;
writing the first processing command into the first shared memory region includes:
setting the first write semaphore to a first state identifier and writing the first processing command into the first shared memory region; where the first state identifier is configured to indicate that the first shared memory region is in a data write state; and
in response to completing the writing of the first processing command, setting the first write semaphore to a second state identifier, and setting the first read semaphore to a third state identifier, such that the second process reads the first processing command from the first shared memory region in response to determining that the first read semaphore is set to the third state identifier, performs the corresponding processing operation based on the first processing command to generate the first processing result, and writes the first processing result into the second shared memory region; where the second state identifier indicates that the first shared memory region is in a data un-write state and the third state identifier indicates that the first shared memory is in a data read state.

In some embodiments, writing the first processing command into the first shared memory region includes:
writing the first processing command into the first shared memory region and locking the first shared memory region;
in response to completing the writing of the first processing command, unlocking the first shared memory region such that the second process reads the first processing command from the first shared memory region in response to determining that the first shared memory region is unlocked, performs the corresponding processing operation based on the first processing command to generate the first processing result, and writes the first processing result into the second shared memory region.

In some embodiments, the first processing command is in a first preset data format; the first processing result is generated based on a second preset data format; and a development language corresponding to the first process is different from a development language corresponding to the second process.

In some embodiments, the first process includes a play process and the second process includes a decoding process; the to-be-processed service request includes a video play request; the first processing command includes a video loading command; and the first processing result includes first indication information;
generating the first processing command includes:
based on the video play request, determining a video loading command identifier and a storage position of a to-be-played video;
based on a first preset data format, performing encapsulation on the video loading command identifier and the storage position of the to-be-played video to obtain the video loading command;
writing the first processing command into the shared memory region includes:
writing the video loading command into the first shared memory region such that the second process, in response to the video loading command identifier in the video loading command, obtains the to-be-played video based on the storage position of the to-be-played video in the video loading command, analyzes the to-be-played video to obtain video information of the to-be-played video, creates a third shared memory region, performs encapsulation on information of the third shared memory region and the video information based on a second preset data format, and writes the first indication information obtained by encapsulation into the second shared memory region; where the third shared memory region is configured to store a decoded to-be-played video.

In some embodiments, the information of the third shared memory region includes a name of the third shared memory region;
the method further includes:
in response to determining that the first indication information is read from the second shared memory region, generating a video play command;
writing the video play command into the first shared memory region; where the video play command is configured to indicate that the second process decodes the to-be-played video and writes the decoded to-be-played video into the third shared memory region;
based on the name of the third shared memory region, reading the decoded to-be-played video from the third shared memory region and playing the decoded to-be-played video.

In some embodiments, the method further includes:
there is one or more to-be-played videos,
creating the shared memory region and determining the startup parameter includes:
in response to determining that the video play request indicates a plurality of to-be-played videos, creating a plurality of shared memory regions, and determining a plurality of startup parameters; where the plurality of startup parameters are in one-to-one correspondence with the plurality of shared memory regions; and each of the plurality of startup parameters is configured to start up one second process.

In some embodiments, the information of the shared memory region includes a name and/or size of the shared memory region;
creating the shared memory region and determining the startup parameter includes:
in response to determining that the second process is in a non-running state, creating the shared memory region and determining the startup parameter;
the method further includes:
in response to determining that the second process is in a running state, generating the first processing command based on the to-be-processed service request.
In some embodiments, the method further includes:
writing first heartbeat data into the shared memory region; where the first heartbeat data is configured to indicate that the second process generates a first response result based on the first heartbeat data and writes the first response result into the shared memory region;
in response to determining that the first response result is not read from the shared memory region within a first preset time, stopping the second process and starting up a new second process.

According to a second aspect of embodiments of the present disclosure, there is provided a service processing method, which is applied to an electronic device configured to perform a second process. The method includes:
obtaining a startup parameter conveyed by a first process, and performing startup based on the startup parameter; where the startup parameter includes information of a shared memory region;
based on the information of the shared memory region, reading a first processing command from the shared memory region; where the first processing command is generated by the first process in response to receiving a to-be-processed service request;
based on the first processing command, performing a processing operation.

In some embodiments, the shared memory region includes a first shared memory region and a second shared memory region;
reading the first processing command from the shared memory region includes:
reading the first processing command from the first shared memory region;
the method further includes:
writing a first processing result into the second shared memory region, such that the first process reads the first processing result from the second shared memory region, and performs a corresponding processing operation based on the first processing result; where the first processing result is obtained by performing the processing operation based on the first processing command.

In some embodiments, the second shared memory region corresponds to a second read semaphore and a second write semaphore;
writing the first processing result into the second shared memory region includes:
setting the second write semaphore to a fourth state identifier, and writing the first processing result into the second shared memory region; where the fourth state identifier is configured to indicate that the second shared memory region is in a data write state;
in response to completing the writing of the first processing result, setting the second write semaphore to a fifth state identifier and setting the second read semaphore to a sixth state identifier, such that the first process reads the first processing result from the second shared memory region in response to determining that the second read semaphore is set to the sixth state identifier; where the fifth state identifier indicates that the second shared memory region is in a data un-write state and the sixth state identifier indicates that the second shared memory region is in a data read state.

In some embodiments, writing the first processing result into the second shared memory region includes:
writing the first processing result into the second shared memory region and locking the second shared memory region;
in response to completing the writing of the first processing result, unlocking the second shared memory region such that the first process reads the first processing result from the second shared memory region.

In some embodiments, the second process includes a decoding process, and the first process includes a play process; the first processing command includes a video loading command and the first processing result includes first indication information;
based on the first processing command, performing the processing operation includes:
based on a storage position of a to-be-played video in the video loading command, obtaining the to-be-played video, and analyzing the to-be-played video to obtain video information of the to-be-played video;
creating a third shared memory region; where the third shared memory region is configured to store a decoded to-be-played video;
based on a second preset data format, performing encapsulation on information of the third shared memory region and the video information to obtain the first indication information;
writing the first processing result into the second shared memory region includes:
writing the first indication information into the second shared memory region such that the first process generates a video play command based on the first indication information and writes the video play command into the first shared memory region.

In some embodiments, the information of the third shared memory region includes a name of the third shared memory region;
the method further includes:
in response to determining that the video play command is read from the first shared memory region, decoding the to-be-played video;
writing the decoded to-be-played video into the third shared memory region such that the first process reads the decoded to-be-played video from the third shared memory region based on the name of the third shared memory region, and plays the decoded to-be-played video.

In some embodiments, the method further includes:
writing second heartbeat data into the shared memory region; where the second heartbeat data is configured to indicate that the first process generates a second response result based on the second heartbeat data and writes the second response result into the shared memory region;
in response to determining that the second response result is not read from the shared memory region within a second preset time, stopping a running operation.

According to a third aspect of embodiments of the present disclosure, there is provided a service processing apparatus, which is applied to an electronic device configured to perform a first process. The apparatus includes:
a request processing module, configured to, in response to receiving a to-be-processed service request, create a shared memory region, and determine a startup parameter, where the startup parameter includes information of the shared memory region;
a parameter processing module, configured to convey the startup parameter to a second process such that the second process is started up based on the startup parameter; where the second process indicates a functional module used to implement the to-be-processed service request;
a command generating module, configured to, based on the to-be-processed service request, generate a first processing command;
a first communication module, configured to write the first processing command into the shared memory region such that the second process reads the first processing command from the shared memory region based on the information of the shared memory, and performs a processing operation based on the first processing command.

In some embodiments, the second process indicates a third-party component; the shared memory region includes a first shared memory region and a second shared memory region; the first shared memory region is configured to store data written by the first process, and the second shared memory region is configured to store data to be read by the first process;
the first communication module is configured to:
write the first processing command into the first shared memory region such that the second process reads the first processing command from the first shared memory region, performs a corresponding processing operation based on the first processing command to obtain a first processing result, and writes the first processing result into the second shared memory region;
the first communication module is further configured to:
read the first processing result from the second shared memory region and based on the first processing result, perform a corresponding processing operation.

In some embodiments, the first shared memory region corresponds to a first read semaphore and a first write semaphore;
the first communication module is further configured to:
set the first write semaphore to a first state identifier and write the first processing command into the first shared memory region; where the first state identifier is configured to indicate that the first shared memory region is in a data write state;
in response to completing the writing of the first processing command, set the first write semaphore to a second state identifier, and set the first read semaphore to a third state identifier, such that the second process reads the first processing command from the first shared memory region in response to determining that the first read semaphore is set to the third state identifier, performs the corresponding processing operation based on the first processing command to generate the first processing result, and writes the first processing result into the second shared memory region; where the second state identifier indicates that the first shared memory region is in a data un-write state and the third state identifier indicates that the first shared memory is in a data read state.

In some embodiments, the first communication module is further configured to:
write the first processing command into the first shared memory region and lock the first shared memory region;
in response to completing the writing of the first processing command, unlock the first shared memory region such that the second process reads the first processing command from the first shared memory region in response to determining that the first shared memory region is unlocked, performs the corresponding processing operation based on the first processing command to generate the first processing result, and writes the first processing result into the second shared memory region.

In some embodiments, the first processing command is in a first preset data format; the first processing result is generated based on a second preset data format; and a development language corresponding to the first process is different from a development language corresponding to the second process.

In some embodiments, the first process includes a play process and the second process includes a decoding process; the to-be-processed service request includes a video play request; the first processing command includes a video loading command; and the first processing result includes first indication information;
the request processing module is further configured to:
based on the video play request, determine a video loading command identifier and a storage position of a to-be-played video;
based on a first preset data format, perform encapsulation on the video loading command identifier and the storage position of the to-be-played video to obtain the video loading command.

In some embodiments, the first communication module is further configured to:
write the video loading command into the first shared memory region such that the second process, in response to the video loading command identifier in the video loading command, obtains the to-be-played video based on the storage position of the to-be-played video in the video loading command, analyzes the to-be-played video to obtain video information of the to-be-played video, creates a third shared memory region, performs encapsulation on information of the third shared memory region and the video information based on a second preset data format, and writes the first indication information obtained by encapsulation into the second shared memory region; where the third shared memory region is configured to store a decoded to-be-played video.

In some embodiments, the information of the third shared memory region includes a name of the third shared memory region;
the first communication module is further configured to:
in response to determining that the first indication information is read from the second shared memory region, generate a video play command;
write the video play command into the first shared memory region; where the video play command is configured to indicate that the second process decodes the to-be-played video and writes the decoded to-be-played video into the third shared memory region;
based on the name of the third shared memory region, read the decoded to-be-played video from the third shared memory region and play the decoded to-be-played video.

In some embodiments, there is one or more to-be-played videos;
the request processing module is further configured to:
in response to determining that the video play request indicates a plurality of to-be-played videos, create a plurality of shared memory regions, and determine a plurality of startup parameters; where the plurality of startup parameters are in one-to-one correspondence with the plurality of shared memory regions; and each of the plurality of startup parameters is configured to start up one second process.

In some embodiments, the information of the shared memory region includes a name and/or size of the shared memory region;
the request processing module is further configured to:
in response to determining that the second process is in a non-running state, create the shared memory region and determine the startup parameter;
the request processing module is further configured to:
in response to determining that the second process is in a running state, generate the first processing command based on the to-be-processed service request.

In some embodiments, the first communication module is further configured to:
write first heartbeat data into the shared memory region; where the first heartbeat data is configured to indicate that the second process generates a first response result based on the first heartbeat data and writes the first response result into the shared memory region;
in response to determining that the first response result is not read from the shared memory region within a first preset time, stop the second process and start up a new second process.

According to a fourth aspect of embodiments of the present disclosure, there is provided a service processing apparatus, which is applied to an electronic device configured to perform a second process. The apparatus includes:
a process startup module, configured to obtain a startup parameter conveyed by a first process, and perform startup based on the startup parameter; where the startup parameter includes information of a shared memory region;
a second communication module, configured to, based on the information of the shared memory region, read a first processing command from the shared memory region; where the first processing command is generated by the first process in response to receiving a to-be-processed service request;
a service processing module, configured to perform a processing operation based on the first processing command.

In some embodiments, the shared memory region includes a first shared memory region and a second shared memory region;
the second communication module is configured to:
read the first processing command from the first shared memory region;
the second communication module is further configured to:
write a first processing result into the second shared memory region, such that the first process reads the first processing result from the second shared memory region, and performs a corresponding processing operation based on the first processing result; where the first processing result is obtained by performing the processing operation based on the first processing command.

In some embodiments, the second shared memory region corresponds to a second read semaphore and a second write semaphore;
the second communication module is further configured to:
set the second write semaphore to a fourth state identifier, and write the first processing result into the second shared memory region; where the fourth state identifier is configured to indicate that the second shared memory region is in a data write state;
in response to completing the writing of the first processing result, set the second write semaphore to a fifth state identifier and set the second read semaphore to a sixth state identifier, such that the first process reads the first processing result from the second shared memory region in response to determining that the second read semaphore is set to the sixth state identifier; where the fifth state identifier indicates that the second shared memory region is in a data un-write state and the sixth state identifier indicates that the second shared memory region is in a data read state.

In some embodiments, the second communication module is further configured to:
write the first processing result into the second shared memory region and lock the second shared memory region;
in response to completing the writing of the first processing result, unlock the second shared memory region such that the first process reads the first processing result from the second shared memory region.

In some embodiments, the second process includes a decoding process, and the first process includes a play process; the first processing command includes a video loading command and the first processing result includes first indication information;
the second communication module is further configured to:
based on a storage position of a to-be-played video in the video loading command, obtain the to-be-played video, and analyze the to-be-played video to obtain video information of the to-be-played video;
create a third shared memory region; where the third shared memory region is configured to store a decoded to-be-played video;
based on a second preset data format, perform encapsulation on information of the third shared memory region and the video information to obtain the first indication information;
the second communication module is further configured to:
write the first indication information into the second shared memory region such that the first process generates a video play command based on the first indication information and writes the video play command into the first shared memory region.

In some embodiments, the information of the third shared memory region includes a name of the third shared memory region;
the second communication module is further configured to:
in response to determining that the video play command is read from the first shared memory region, decode the to-be-played video;
write the decoded to-be-played video into the third shared memory region such that the first process reads the decoded to-be-played video from the third shared memory region based on the name of the third shared memory region, and plays the decoded to-be-played video.

In some embodiments, the second communication module is further configured to:
write second heartbeat data into the shared memory region; where the second heartbeat data is configured to indicate that the first process generates a second response result based on the second heartbeat data and writes the second response result into the shared memory region;
in response to determining that the second response result is not read from the shared memory region within a second preset time, stop a running operation.

According to a fifth aspect of embodiments of the present disclosure, there is provided an electronic device, including:
a processor;
a memory storing processor executable instructions;
where the processor is configured to:
in response to receiving a to-be-processed service request, create a shared memory region, and determine a startup parameter, where the startup parameter includes information of the shared memory region;
convey the startup parameter to a second process such that the second process is started up based on the startup parameter; where the second process indicates a functional module used to implement the to-be-processed service request;
based on the to-be-processed service request, generate a first processing command;
write the first processing command into the shared memory region such that the second process reads the first processing command from the shared memory region based on the information of the shared memory, and performs a processing operation based on the first processing command.

According to a sixth aspect of embodiments of the present disclosure, there is provided an electronic device, including:
a processor;
a memory storing processor executable instructions;
where the processor is configured to:
obtain a startup parameter conveyed by a first process, and perform startup based on the startup parameter; where the startup parameter includes information of a shared memory region;
based on the information of the shared memory region, read a first processing command from the shared memory region; where the first processing command is generated by the first process in response to receiving a to-be-processed service request;
based on the first processing command, perform a processing operation.

According to a seventh aspect of embodiments of the present disclosure, there is provided a computer readable storage medium, storing computer executable instructions, where the computer executable instructions are executed by a processor to perform the service processing methods mentioned and probably designed in the above first aspect.

According to an eighth aspect of embodiments of the present disclosure, there is provided a computer readable storage medium, storing computer executable instructions, where the computer executable instructions are executed by a processor to perform the service processing methods mentioned and probably designed in the above second aspect.

According to a ninth aspect of embodiments of the present disclosure, there is provided a computer program product, including a computer program, where the computer program is executed by a processor to perform the service processing methods mentioned and probably designed in the above first aspect.

According to a tenth aspect of embodiments of the present disclosure, there is provided a computer program product, including a computer program, where the computer program is executed by a processor to perform the service processing methods mentioned and probably designed in the above second aspect.

The technical solutions provided by the embodiments of the present disclosure have the following beneficial effects.

In the embodiments of the present disclosure, in response to receiving a to-be-processed service request, the first process creates a shared memory region and determines a startup parameter for starting the second process based on information of the shared memory region, that is, the first process determines a functional module for implementing relevant service functions, that is, determines a second process corresponding to the functional module, and uses the startup parameter to start up the second process. The first process generates a first processing command based on the to-be-processed service request, and writes the first processing command into the shared memory region such that the second process reads the first processing command from the shared memory region based on the information of the shared memory region and performs a corresponding processing operation based on the first processing command, so as to achieve corresponding service function. In the present disclosure, the functional module with unreliable instability is designed as separate process for running such that the second process corresponding to the functional module is run in isolation with the first process. When a relevant to-be-processed service request is received, which indicates a corresponding functional module is to be used, communication is performed with the second process corresponding to the functional module by using a shared memory so as to perform corresponding service processing using the second process. In this case, even if the second process crashes during running due to instability, no impact will be brought to the first process, ensuring the stable running of the first process, that is, ensuring the stable running of the program corresponding to the first process. In this way, on the basis of achieving the service function, the running stability of the program is guaranteed. Furthermore, in the present disclosure, only when the second process is to be invoked can the shared memory region be created, avoiding invalid creation of the shared memory region and hence avoiding waste of resources. Moreover, the information of the shared memory region is conveyed to the second process based on a startup parameter, such that the second process can perform communication with the first process based on the information of the shared memory region to ensure successful communication between the second process and the first process.

It should be understood that the above general descriptions and subsequent detailed descriptions are merely illustrative and explanatory rather than limiting of the present disclosure.

### BRIEF DESCRIPTION OF DRAWINGS

The drawings herein incorporated in and constituting a part of the present disclosure illustrate embodiments consistent with the present disclosure and explain the principle of the present disclosure together with the specification.

FIG. 1 is a scenario application diagram illustrating a service processing method according to an exemplary embodiment of the present disclosure.

FIG. 2 is a flowchart illustrating a service processing method according to an exemplary embodiment of the present disclosure.

FIG. 3 is a flowchart illustrating another service processing method according to an exemplary embodiment of the present disclosure.

FIG. 4 is a schematic diagram illustrating a shared memory region according to an exemplary embodiment of the present disclosure.

FIG. 5 is a flowchart illustrating another service processing method according to an exemplary embodiment of the present disclosure.

FIG. 6 is a flowchart illustrating another service processing method according to an exemplary embodiment of the present disclosure.

FIG. 7 is a hardware structure diagram illustrating a computer device where a service processing apparatus is located according to an exemplary embodiment of the present disclosure.

FIG. 8 is a block diagram illustrating a service processing apparatus according to an exemplary embodiment of the present disclosure.

FIG. 9 is a block diagram illustrating another service processing apparatus according to an exemplary embodiment of the present disclosure.

### DETAILED DESCRIPTION

Exemplary embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular embodiments only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although the terms “first,” “second,” “third,” or the like may be used in the present disclosure to describe various information, such information should not be limited to these terms. These terms are only used to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”.

The embodiments of the present disclosure will be detailed below.

FIG. 1 is a scenario application diagram illustrating a service processing method according to an exemplary embodiment of the present disclosure. A first process and a second process are processes on an electronic device. When the first process is to communicate with the second process, the communication may be achieved by using a shared memory region, namely, the first process writes data into the shared memory region and the second process reads data from the shared memory region, and/or, the second process writes data into the shared memory region and the first process reads data from the shared memory region.

It can be understood that the operations performed by the first process and the second process are actually performed by a processor on the electronic device where the shared memory region is located.

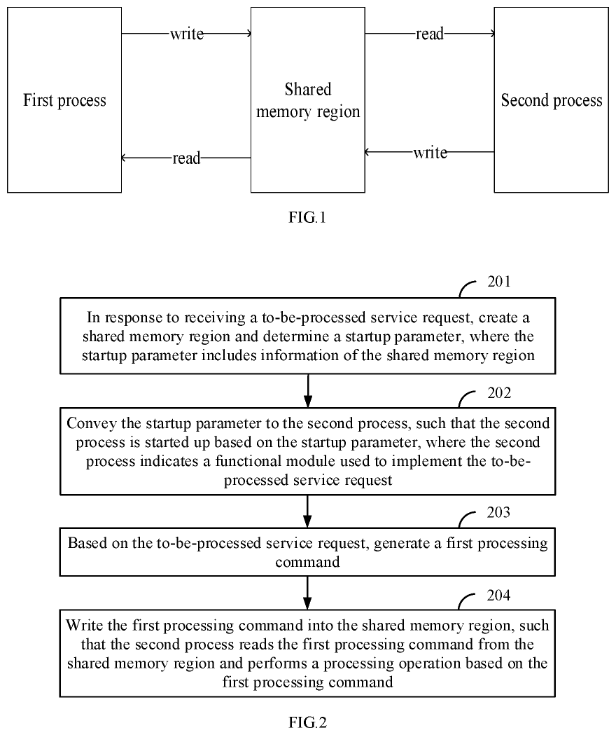

FIG. 2 is a flowchart illustrating a service processing method according to an exemplary embodiment of the present disclosure. The method is applied to an electronic device. The electronic device is configured to perform a first process. The method includes the following steps.

At step 201, in response to receiving a to-be-processed service request, a shared memory region is created and a startup parameter is determined, where the startup parameter includes information of the shared memory region.

In this embodiment, when a to-be-processed service request is obtained, which indicates another process (i.e. a second process) is to be invoked to perform relevant service processing, a shared memory region is created and information of the shared memory region is determined. Based on the information of the shared memory region, a startup parameter for starting up the second process is generated, such that the first process can successfully invoke the second process. The shared memory region is used to achieve communication between the first process and the second process.

In some embodiments, the information of the shared memory region includes a name and/or size of the shared memory region. In some embodiments, the shared memory region may be named anonymously and thus, there is no need for the first process to agree on a name with the corresponding second process every time a pair of processes is started up for communication.

In some embodiments, the first process may further name the created shared memory region based on a naming rule agreed with the second process, that is, based on a preset naming rule, the name of the shared memory region can be determined and thus, the first process does not need to convey the name of the shared memory region to the second process.

At step 202, the startup parameter is conveyed to the second process, such that the second process is started up based on the startup parameter, where the second process indicates a functional module used to implement the to-be-processed service request.

In this embodiment, after the startup parameter is obtained, a running path of the second process to be invoked is obtained, and then by using the running path, the startup parameter is conveyed to the second process to be invoked, such that the second process is started up based on the startup parameter. Thus, the information of the shared memory region is conveyed to the second process based on the startup parameter, such that the second process queries for the shared memory region based on the information of the shared memory region, where the second process indicates a functional module used to implement the service function corresponding to the to-be-processed service request.

It can be understood that when the startup parameter is conveyed to the second process, the startup parameter is actually conveyed to a function or method corresponding to the second process to control the startup of the second process.

In some embodiments, the first process indicates a program and is equivalent to a main process; and the first process is generated upon the startup of the program.

In some embodiments, the functional module is an encapsulation set of codes used to implement part or all of the service function corresponding to the to-be-processed service request, where the functional module is unreliable in stability.

In some embodiments, the second process indicates a third-party component provided by a third-party company, namely, the functional module corresponding to the second process is the third-party component. The second process is equivalent to a child process which is started up by the first process.

In this embodiment, to invoke the second process, the second process should be firstly started up. When the second process is started up, the startup parameter is determined. The startup parameter includes the information of the shared memory region, and the information further includes a name and/or size of the shared memory region. The startup parameter is conveyed to the second process and thus the second process can be started up based on the startup parameter. Therefore, the second process can know the circumstance of the shared memory region based on the startup parameter, and further communicate with the first process via the shared memory region.

At step 203, based on the to-be-processed service request, a first processing command is generated.

At step 204, the first processing command is written into the shared memory region, such that the second process reads the first processing command from the shared memory region and performs a processing operation based on the first processing command.

In this embodiment, when the to-be-processed service request is obtained, which indicates relevant service function is to be executed, the first processing command corresponding to the to-be-processed service request is generated. The first processing command is written into the shared memory region such that the second process with unreliable stability communicates with the first process via the shared memory region. Namely, the second process reads the first processing command from the shared memory region and performs corresponding service processing based on the first processing command, so as to achieve relevant service function.

In some embodiments, the to-be-processed service request may include different types of service requests, for example, a temperature alarm request or a video play request or the like. The to-be-processed service request may be input by a user based on actual requirements or generated automatically, which is not limited herein.

With a specific application scenario as an example, the to-be-processed service request is a temperature alarm request which indicates that an alarm is given when a working temperature of a target production equipment is greater than a preset temperature threshold. For this reason, it is required to obtain the working temperature of the target production equipment. At this time, it is required to obtain a temperature detected by a relevant temperature sensor of the target production equipment by using a temperature detection function module, and then a temperature detection command (i.e. the first processing command) is generated and sent to the second process corresponding to the temperature detection function module. In this case, the second process can communicate with the relevant temperature sensor of the target production equipment to obtain the working temperature of the target production equipment.

In some embodiments, after a functional module to be used is determined, if the second process corresponding to the functional module is in a non-running state, it indicates that the second process is not started up and thus the shared memory region is created and the startup parameter is determined, so as to start up the second process based on the startup parameter, thereby running the second process. When the second process is in a running state, it indicates that the second process is already started up and thus the first processing command is generated based on the to-be-processed service request so as to perform service processing directly using the second process.

In this embodiment, when the to-be-processed service request is received, namely, when another process (i.e. the second process) is to be invoked to perform corresponding service function, that is, when an invoke relationship is to be generated, the shared memory region is created so as to communicate with the second process via the shared memory region. Compared with the fact that the shared memory region is pre-created and is directly used to communicate with the second process upon receiving the to-be-processed service request, in the present disclosure, invalid creation of the shared memory region may be avoided and occupation of the resources resulting from the invalid shared memory region may also be avoided, so as to avoid resource wastes.

In this embodiment, a name is allocated to the shared memory region in an anonymous manner. Compared with naming the shared memory region based on a naming rule, this naming manner is more flexible such that the second process does not need to pre-store the name of the shared memory region. In this way, name repetition may be avoided to some extent, bringing wider application scope.

In this embodiment of the present disclosure, after the startup of the program, the first process determines a service function to be achieved based on the to-be-processed service request, that is, determines a functional module used to achieve this service function. When the functional module is not running, the functional module is started up, namely, the second process corresponding to the functional module is started up such that corresponding service processing is performed by using the second process, so as to achieve corresponding service function. Compared with the fact that the functional module is integrated into the program to serve as a part of the program and a service function is achieved by using a process (i.e. the first process) generated during program startup, in the present disclosure, the functional module with unreliable instability is isolated from the program such that the program is free from the influence of the functional module, that is, the first process is free from the influence of the second process. In this case, even if the second process runs abnormally, the first process can still run normally, so as to ensure the running stability of the first process and thus improve the stability of the program.

It can be known from the above that, in response to receiving a to-be-processed service request, the first process creates a shared memory region and determines a startup parameter based on information of the shared memory region such that the second process is started up based on the startup parameter. That is, the first process determines a functional module used to implement relevant service function, that is, determines a second process corresponding to the functional module, and starts up the second process based on the startup parameter. The first process generates a first processing command based on the to-be-processed service request, and writes the first processing command into the shared memory region such that the second process reads the first processing command from the shared memory region based on the information of the shared memory region, and performs a corresponding processing operation based on the first processing command, so as to achieve corresponding service function. In the present disclosure, the functional module with unreliable instability is designed as separate process for running such that the second process corresponding to the functional module is run in isolation with the first process. When a relevant to-be-processed service request is received, which indicates a corresponding functional module is to be used, communication is performed with the second process corresponding to the functional module by using a shared memory region so as to perform corresponding service processing using the second process. In this case, even if the second process crashes during running due to instability, no impact will be brought to the running of the first process, ensuring the stable running of the first process, that is, ensuring the stable running of the program corresponding to the first process. In this way, on the basis of achieving the service function, the running stability of the program is guaranteed. Furthermore, in the present disclosure, only when the second process is to be invoked can the shared memory region be created, avoiding invalid creation of the shared memory region and hence avoiding waste of resources. Moreover, the information of the shared memory region is conveyed to the second process based on a startup parameter, such that the second process can perform communication with the first process based on the information of the shared memory region to ensure successful communication between the second process and the first process.

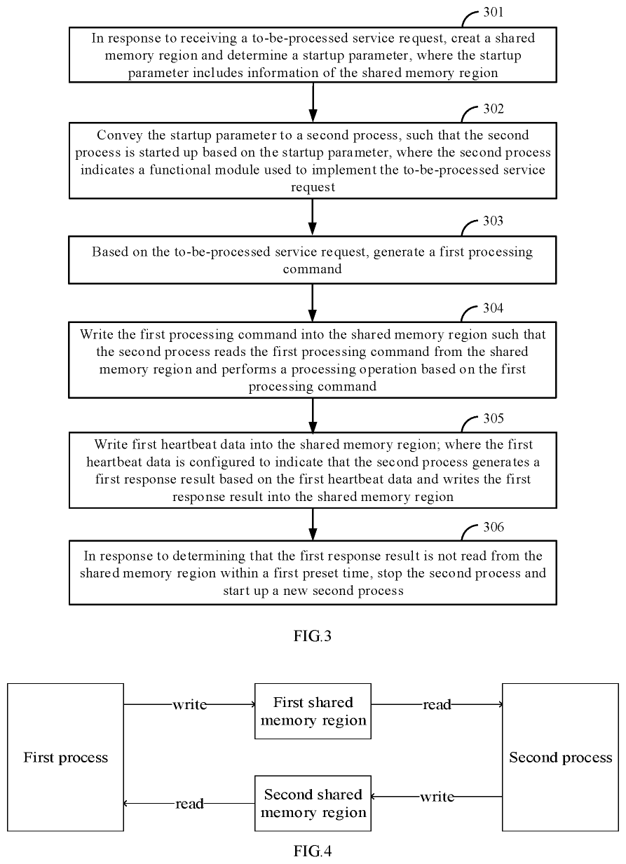

FIG. 3 is a flowchart illustrating another service processing method according to an exemplary embodiment of the present disclosure. On the basis of the above embodiments, whether the second process runs normally can be detected by an anomaly detection mechanism. This procedure will be detailed below with a specific example. As shown in FIG. 3, the method includes the following steps.

At step 301, a shared memory region is created and a startup parameter is determined, where the startup parameter includes information of the shared memory region.

At step 302, the startup parameter is conveyed to a second process, such that the second process is started up based on the startup parameter, where the second process indicates a functional module used to implement a to-be-processed serviced request.

At step 303, based on the to-be-processed service request, a first processing command is generated.

In this embodiment, the first process, after being started up, creates the shared memory region and allocates a name to the shared memory region so as to use the shared memory region based on the name of the shared memory region (e.g. write data into the shared memory region).

In some embodiments, to avoid read-write conflict, a first shared memory region and a second shared memory region may be created respectively during creation of the shared memory region, namely, the shared memory region includes the first shared memory region and the second shared memory region.

As shown in FIG. 4, the first shared memory region is used to store data written by the first process, that is, the first shared memory region is used to store data to be read by the second process. The second shared memory region is used to store data to be read by the first process, that is, the second shared memory region is used to store data written by the second process.

In some embodiments, when the shared memory region includes the first shared memory region and the second shared memory region, the information of the shared memory region includes a name and/or size of the first shared memory region and a name and/or size of the second shared memory region.

The size of the shared memory region is determined based on a size of data written by the process during communication. For example, if the length of the data written by the first process is 272 bytes and the length of the data written by the second process is 288 bytes, the size of the shared memory region may be set to no less than 288 bytes accordingly.

In some embodiments, when the shared memory region includes the first shared memory region and the second shared memory region which are named based on an agreed naming rule, the name of the first shared memory region and the name of the second shared memory region are determined based on a preset naming rule, such that the second process can directly know the name of the shared memory region (i.e. the names of the first shared memory region and the second shared memory region) created by the first process, and thus use the shared memory to perform unidirectional or bidirectional communication.

The preset naming rule may be set based on actual requirements. For example, if the first process is a play process, the name of the first shared memory region may be video_shared_memory_w, and the name of the second shared memory region may be video_shared_memory_r. In some embodiments, the first process writes data into the shared memory region corresponding to video_shared_memory_w and the second process reads data from the shared memory region corresponding to video_shared_memory_w; and the second process writes data into the shared memory region corresponding to video_shared_memory_r and the first process reads data from the shared memory region corresponding to video_shared_memory_r.

At step 304, the first processing command is written into the shared memory region such that the second process reads the first processing command from the shared memory region and performs a processing operation based on the first processing command.

In this embodiment, the shared memory region includes the first shared memory region and the second shared memory region, the first process writes the first processing command into the first shared memory region such that the second process reads the first processing command from the first shared memory region and performs a corresponding processing operation based on the first processing command to obtain a first processing result, and then writes the first processing result into the second shared memory region. The first process reads the first processing result from the second shared memory region and performs a corresponding processing operation based on the first processing result. In this way, data write conflict resulting from the first process and the second process writing data into the shared memory region simultaneously may be avoided.

In some embodiments, to ensure communication reliability, avoid read-write conflict, and further allow the processes (i.e. the first process and the second process) to know in timely manner whether to read/write data, it is possible to ensure that only one process performs data read or data write on the first shared memory region by using mutually-exclusive semaphores or mutually-exclusive locks.

When the read-write conflict of the first shared memory region is avoided by using the mutually-exclusive semaphores, the first shared memory region corresponds to a first read semaphore and a first write semaphore. Correspondingly, the first write semaphore is set to a first state identifier and the first processing command is written into the first shared memory region. The first state identifier is used to indicate that the first shared memory region is in a data write state. When the write of the first processing command is completed, the first write semaphore is set to a second state identifier, and the first read semaphore is set to a third state identifier, such that the second process, in response to determining that the first read semaphore is set to the third state identifier, reads the first processing command from the first shared memory region, performs a corresponding processing operation based on the first processing command to generate a first processing result, and writes the first processing result into the second shared memory region. The second state identifier indicates that the first shared memory region is in a data un-write state and the third state identifier indicates that the first shared memory region is in a data read state.

In some embodiments, when the first process writes data (i.e. the first processing command) into the first shared memory region, the first write semaphore is changed to the first state identifier to indicate that the first shared memory region is in a data write state and the other process cannot read data. After the first process completes the data write, that is, after the first process writes the first processing command into the first shared memory region, the first read semaphore is set to the third state identifier to indicate that the other process can read data from the first shared memory region. In this case, the second process, in response to determining that the first read semaphore is set to the third state identifier, knows in a timely manner that data can be read from the first shared memory region, reads the first processing command from the first shared memory region in a timely manner, and uses the first processing command to perform relevant service processing to generate the first processing result. After obtaining the first processing result, the second process writes the first processing result into the second shared memory region.

When the first process writes data into the first shared memory region, the first read semaphore corresponding to the first shared memory region is set to a seventh state identifier, which indicates that the first shared memory region is in a data un-read state, that is, it indicates that the other process cannot read data from the first shared memory region.

When the second process reads the first processing command from the first shared memory region, the first write semaphore corresponding to the first shared memory region is changed to the second state identifier which indicates that the first process cannot write data into the first shared memory region.

When the read-write conflict is avoided by using the mutually-exclusive locks, the first processing command is written into the first shared memory region and then the first shared memory region is locked. When the write of the first processing command is completed, the first shared memory region is unlocked such that the second process, in response to determining that the first shared memory region is unlocked, reads the first processing command from the first shared memory region, performs a corresponding processing operation based on the first processing command to generate the first processing result, and writes the first processing result into the second shared memory region.

In some embodiments, when the first process writes data into the first shared memory region, the first shared memory region is locked to prevent the other process from reading data from the first shared memory region. After the first process writes data into the first shared memory region, it indicates that the second process can know in a timely manner that data can be read from the first shared memory region and read data from the first shared memory region in a timely manner. In this case, the first process unlocks the first shared memory region to allow the second process to access the first shared memory region, so as to read the first processing command from the first shared memory region.

In some embodiments, when the second process accesses the first shared memory region, the second process can lock the first shared memory region and after accessing or after completing data read, unlock the first shared memory region. Thus, the first process can know in timely manner that data write can be performed on the first shared memory region.

In some embodiments, the first process may include processes corresponding to different types of programs, for example, if the program is a video play software, the first process includes a play process, the second process includes a decoding process and the to-be-processed service request includes a video play request. Correspondingly, the first processing command includes a video loading command and the first processing result includes first indication information.

In some embodiments, when a user starts up the video play software on the electronic device, the electronic device starts up the play process. When the video play request is received, a video loading command identifier and a storage position of a to-be-played video are determined based on the video play request. Based on a first preset data format, the video loading command identifier and the storage position of the to-be-played video are encapsulated to obtain a video loading command. The video loading command is written into the first shared memory region such that the second process, in response to the video loading command identifier in the video loading command, obtains the to-be-played video based on the storage position of the to-be-played video in the video loading command, analyzes the to-be-played video to obtain video information of the to-be-played video, creates a third shared memory region, performs encapsulation on information of the third shared memory region and the video information based on a second preset data format, and writes the first indication information obtained by encapsulation into the second shared memory region; where the third shared memory region is used to store a decoded to-be-played video.

In some embodiments, when the user triggers a relevant control (e.g. the user selects a particular video) in the video play software, an identifier of the to-be-played video is determined and a video play request containing the identifier of the to-be-played video is generated. After the first process obtains the video play request, it indicates that the to-be-played video is to be loaded by using the second process to perform decoding. Based on the identifier of the to-be-played video in the video play request, the storage position of the to-be-played video is queried for and a video loading command identifier corresponding to the video play request is determined. Based on the first preset data format, the video loading command identifier and the storage position of the to-be-played video are encapsulated to obtain a video loading command and then the video loading command is written into the first shared memory region.

After the second process reads the video loading command from the first shared memory region, the second process executes the video loading command, that is, in response to the video loading command identifier in the video loading command, obtains the to-be-played video from the storage position of the to-be-played video and analyzes the to-be-played video to obtain video information of the to-be-played video, so as to load the to-be-played video, thus completing initialization. Since the video data volume is huge, to avoid the insufficient size of the second shared memory region, the second process may create a third shared memory region which is used to store decoded video data. To allow the first process to read data from the third shared memory region, the second process, after successfully performing video loading, performs encapsulation on information of the third shared memory region and the video information of the to-be-played video based on the second preset data format to obtain the first indication information and writes the first indication information into the second shared memory region.

The video information includes information such as width, height, play time length or the like of the to-be-played video. The information of the third shared memory region includes a name and/or size of the third shared memory region.

In some embodiments, in response to determining that the first indication information is read from the second shared memory region, a video play command is generated and written into the first shared memory region. The video play command is used to indicate that the second process performs decoding on the to-be-played video and writes the decoded to-be-played video into the third shared memory region. Based on the name of the third shared memory region, the decoded to-be-played video is read from the third shared memory region and played.

In some embodiments, after the first process reads the first indication information from the second shared memory region, the first process determines that the second process successfully loads the video and can perform video decoding by using the second process. The first process initializes a player control based on the video information of the to-be-played video in the first indication information and obtains a video play command identifier. Based on the first preset data format, the video play command identifier is encapsulated to generate a video play command, and the video play command is then written into the first shared memory region. After reading the video play command from the first shared memory region, the second process, in response to the video play command identifier in the video play command, performs decoding on the to-be-played video to obtain a decoded to-be-played video and writes the decoded to-be-played video into the third shared memory region. The first process queries for the third shared memory region by using the name of the third shared memory region, reads the decoded to-be-played video from the third shared memory region, and refreshes the player control so as to play the decoded to-be-played video by using the player control.

In some embodiments, the second process may, when performing decoding on the to-be-played video, perform decoding in the form of video frame, namely, perform decoding on the video frames in the to-be-played video so as to play it while decoding.

In some embodiments, the video play command may be generated automatically upon reading the first indication information returned by the second process or generated by trigger of the user (for example, the user clicks on the player control).

The electronic device may store a correspondence between request and command, for example, after a video play request is obtained, it indicates that a video loading command is to be generated. In this case, a video loading command identifier is queried for.

In some embodiments, the identifier of the to-be-played video may be a name or serial number of the to-be-played video and may include characters such as letters, digits, words or the like. Command identifiers (e.g. the video loading command identifier or the video play command identifier) may further include characters such as letters, digits, words or the like. For example, the video loading command identifier is 0 and the video play command identifier is 1.

In some embodiments, the first process, i.e. the play process, may further obtain another command identifier based on requirements, and based on the first preset data format, generate another command for achieving play control, for example, a play pause command, a play progress drag command, a sound setting command, or a play stop command. Accordingly, the second process may further generate another type of processing result.

In some embodiments, the first processing result generated by the second process may further include a corresponding result identifier. For example, when the second process generates the first indication information, the second process obtains a video loading success identifier, i.e. an initialization completion identifier. Thus, the first indication information generated based on the second preset data format further includes the initialization completion identifier.

The first preset data format and the second preset data format may be set based on actual requirements. For example, the first preset data format and the second preset data format may be a data format such as struct, json or xml or the like.

In some embodiments, the first preset data format is struct PlayMsg{
int command;//command identifier, 0—video loading command identifier, 1—video play command identifier, 2—play pause command identifier, 3—play progress drag command identifier, 4—sound setting command identifier, 5—play stop command identifier, 6—heartbeat identifier
string src;//storage position, when command is 0, valid for loading
int vol;//value range is 0 to 100, when command is 4, valid for sound setting
long time;//play time point to which the drag proceeds to in the unit of millisecond, when command is 3, valid for dragging play progress
}.

In some embodiments, the second preset data format is struct DecodeMsg{
int command;//result identifier, 0—initialization completion identifier, 1—loading result identifier, 2—decodig completion identifier, 3—heartbeat identifier
int width;//pixel width of video
int height;//pixel height of video
long duration;//total time length of video
long time;//current play position of video
string data_sm;//name of third shared memory region, when command is 1, valid
int data_size; //size of third shared memory region, when command is 1, valid
}.

In this embodiment, since the video data volume obtained by the second process through decoding is huge, when the decoded video data is written into the second shared memory region, a long time will be required. When the second process is to communicate with the first process, the second process cannot achieve communication with the first process via the second shared memory region during the write of the decoded video data because the second shared memory region is occupied. As a result, to improve communication efficiency, a third shared memory region is created such that the second process can still communicate with the first process via the second shared memory region when writing the decoded video data into the third shared memory region.

In some embodiments, there may be one or more to-be-played videos. Accordingly, creating the shared memory region and determining the startup parameter may include:
in response to determining that the video play request indicates a plurality of to-be-played videos, creating a plurality of shared memory regions, and determining a plurality of startup parameters; where the plurality of startup parameters are in one-to-one correspondence with the plurality of shared memory regions; and each startup parameter is used to start up one second process.

In some embodiments, when multiple videos (i.e. to-be-played videos) are to be played, multiple second processes may be started up, and each second process is used to decode one to-be-played video. That is, for each second process, a shared memory region corresponding to the second process is created and a startup parameter corresponding to the second process is determined based on information of the shared memory region corresponding to the second process, such that the second process is started up based on the startup parameter corresponding to the second process. Thus, by decoding one to-be-played video using the second process, multiple videos can be decoded in parallel so as to enable the first process to play multiple videos at the same time, meeting the play needs of the user.

In this embodiment, the first processing command is in a first preset data format, namely, the command generated by the first process to be sent to the second process is based on the first preset data format. The first process result is generated based on a second preset data format, namely, the processing result generated by the second process to be sent to the first process is generated based on the second preset data format. The first preset data format and the second preset data format are defined by the first process and the second process, and thus, the first process and the second process can analyze data from the other party to successfully achieve inter-process communication. Hence, the development language corresponding to the first process may differ from the development language corresponding to the second process to achieve communication across language platform.

At step 304, first heartbeat data is written into the shared memory region; where the first heartbeat data is configured to indicate that the second process generates a first response result based on the first heartbeat data and writes the first response result into the shared memory region.

In this embodiment, the first process generates the first heartbeat data based on the first preset data format at an interval of a third preset time (e.g. one minute), and writes the first heartbeat data into the shared memory region. When the second process runs normally, the second process reads the first heartbeat data from the shared memory region and generates a corresponding first response result, and then writes the first response result into the shared memory region so as to achieve feedback of the heartbeat data.

At step 305, in response to determining that the first response result is not read from the shared memory region within a first preset time, the second process is stopped and a new second process is started up.

In this embodiment, if the first process fails to read the first response result returned by the second process from the shared memory region within the first preset time after writing the first heartbeat data into the shared memory region, it indicates that the second process runs abnormally. To ensure normal running of the service, the running of the second process is stopped and a new second process is started up so as to continue service processing based on the new second process, for example, a new decoding process is started up to perform video decoding.

FIG. 5 is a flowchart illustrating another service processing method according to an exemplary embodiment of the present disclosure. The method is applied to an electronic device configured to perform a second process. As shown in FIG. 5, the method includes the following steps.

At step 501, a startup parameter conveyed by a first process is obtained, and startup is performed based on the startup parameter; where the startup parameter includes information of a shared memory region.

At step 502, based on the information of the shared memory region, a first processing command is read from the shared memory region; where the first processing command is generated by the first process in response to receiving a to-be-processed service request.

At step 503, based on the first processing command, a processing operation is performed.

In this embodiment, after receiving the startup parameter from the first process, the second process is started up based on the startup parameter. If the second process determines during running that the first process writes data into the shared memory region, the second process reads data from the shared memory region, that is, reads the first processing command, and based on the first processing command, performs relevant service processing to achieve corresponding service function.

In this embodiment, an unstable and un-trusted functional module (e.g. a third-party component) is run in isolation by a separate process (the second process), namely, the functional module is taken as an independent program. When the first process needs to invoke a relevant function module to achieve a specific service function, the first process may communicate with the second process corresponding to the functional module via the share memory region to flexibly combine different programs to work together. In this way, synergic and efficient operation of multiple processes may be achieved and the stable running of the first process is ensured, so as to avoid crash of the first process due to instability of a particular module.

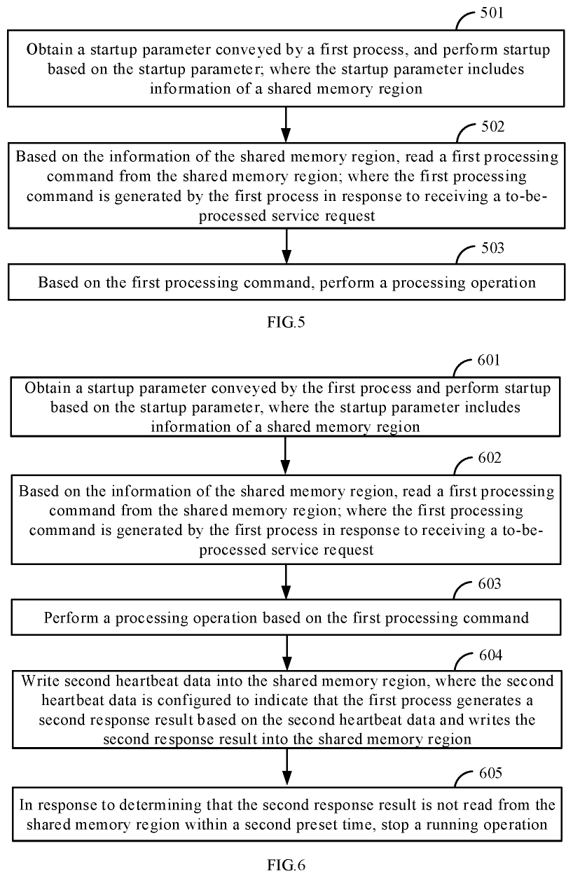

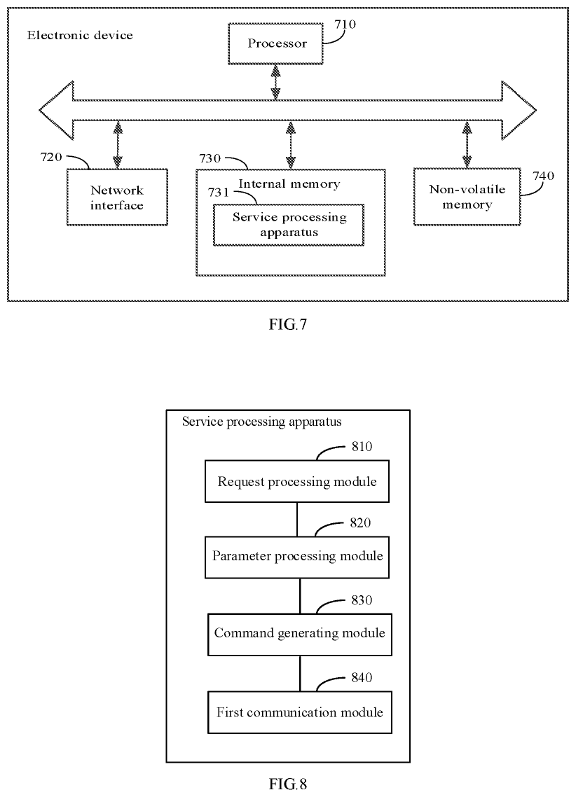

FIG. 6 is a flowchart illustrating another service processing method according to an exemplary embodiment of the present disclosure. On the basis of the above embodiments, whether the second process runs normally can be detected by an anomaly detection mechanism. This procedure will be detailed below with a specific embodiment. As shown in FIG. 6, the method includes the following steps.

At step 601, a startup parameter conveyed by the first process is obtained and startup is performed based on the startup parameter, where the startup parameter includes information of a shared memory region.

At step 602, based on the information of the shared memory region, a first processing command is read from the shared memory region; where the first processing command is generated by the first process in response to receiving a to-be-processed service request.

In this embodiment, the shared memory region includes a first shared memory region and a second shared memory region. To ensure communication reliability and avoid read-write conflict, it is ensured that only one process performs data read or data write on the second shared memory region, by using mutually-exclusive semaphores or mutually-exclusive locks.

In some embodiments, when the read-write conflict of the second shared memory region is avoided by using the mutually-exclusive semaphores, the second shared memory region corresponds to a second read semaphore and a second write semaphore. Correspondingly, the second write semaphore is set to a fourth state identifier and the first processing result is written into the second shared memory region. The fourth state identifier is used to indicate that the second shared memory region is in a data write state. When the write of the first processing result is completed, the second write semaphore is set to a fifth state identifier, and the second read semaphore is set to a sixth state identifier, such that the first process, in response to determining that the second read semaphore is set to the sixth state identifier, reads the first processing result from the second shared memory region. The fifth state identifier indicates that the second shared memory region is in a data un-write state and the sixth state identifier indicates that the second shared memory region is in a data read state.

The process of avoiding the read-write conflict of the second shared memory region by using the mutually-exclusive semaphores is similar to the process of avoiding the read-write conflict of the first shared memory region by using the mutually-exclusive semaphores and thus will not be repeated herein.

In some embodiments, when the read-write conflict of the second shared memory region is avoided by the mutually-exclusive locks, the first process result is written into the second shared memory region and the second shared memory region is locked. When the write of the first processing result is completed, the second shared memory region is unlocked such that the first process reads the first processing result from the second shared memory region.

The process of avoiding the read-write conflict of the second shared memory region by using the mutually-exclusive locks is similar to the process of avoiding the read-write conflict of the first shared memory region by using the mutually-exclusive locks and thus will not be repeated herein.

In some embodiments, the second process includes a decoding process, and the first process includes a play process; the first processing command includes a video loading command and the first processing result includes first indication information.

In some embodiments, based on the first processing command, performing the corresponding processing operation includes:
based on a storage position of a to-be-played video in the video loading command, obtaining the to-be-played video, and analyzing the to-be-played video to obtain video information of the to-be-played video;
creating a third shared memory region; where the third shared memory region is configured to store a decoded to-be-played video;
based on a second preset data format, performing encapsulation on information of the third shared memory region and the video information to obtain the first indication information; and
writing the first indication information into the second shared memory region such that the first process generates a video play command based on the first indication information and writes the video play command into the first shared memory region.

At step 603, a processing operation is performed based on the first processing command.

At step 604, second heartbeat data is written into the shared memory region, where the second heartbeat data is configured to indicate that the first process generates a second response result based on the second heartbeat data and writes the second response result into the shared memory region.

In this embodiment, the second process generates the second heartbeat data based on the second preset data format at an interval of a fourth preset time (e.g. one minute) and writes the second heartbeat data into the shared memory region. When the second process runs normally, the first process reads the second heartbeat data from the shared memory region and generates the corresponding second response result, and then writes the second response result into the shared memory region, so as to achieve feedback of the heartbeat data.

At step 605, in response to determining that the second response result is not read from the shared memory region within a second preset time, a running operation is stopped.

In this embodiment, if the second process fails to read the second response result returned by the first process from the shared memory region within the second preset time after writing the second heartbeat data into the shared memory region, it indicates that the first process runs abnormally. To avoid resource occupation, the second process stops performing running operation, namely, the second process actively disables itself so as to avoid invalid operation of the still-running second process when a newly-enabled first process performs service processing by starting up a new second process without using the second process, further leading to resource occupation of the second process.

Corresponding to the above method embodiments, the present disclosure further provides an embodiment of an apparatus and an electronic device to which it is applied.

The embodiment of the service processing apparatus of the present disclosure may be applied to an electronic device, for example, to a server or a terminal device (e.g. computer, or a mobile terminal or the like). The apparatus embodiment may be implemented by software or by hardware or by combination of hardware and software. With software implementation as an example, as a logical apparatus, it is formed by reading corresponding computer program instructions in a non-volatile memory by a service processing processor into the internal memory for running. From hardware level, as shown in FIG. 7, it is a hardware structure diagram illustrating an electronic device where the service processing apparatus is located according to an embodiment of the present disclosure. In addition to a processor 710, an internal memory 730, a network interface 720 and a non-volatile memory 740 shown in FIG. 7, the electronic device where the service processing apparatus 731 is located in the embodiments may further include other hardware based on the actual function of the electronic device, and no redundant descriptions are made herein.

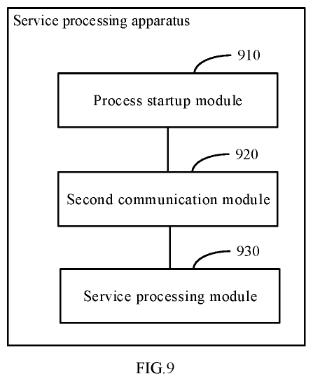

FIG. 8 is a block diagram illustrating a service processing apparatus according to an exemplary embodiment of the present disclosure, where the apparatus is applied to a first process. The apparatus includes:
a request processing module 810, configured to, in response to receiving a to-be-processed service request, create a shared memory region, and determine a startup parameter, where the startup parameter includes information of the shared memory region;
a parameter processing module 820, configured to convey the startup parameter to a second process such that the second process is started up based on the startup parameter; where the second process indicates a functional module used to implement the to-be-processed service request;
a command generating module 830, configured to, based on the to-be-processed service request, generate a first processing command;
a first communication module 840, configured to write the first processing command into the shared memory region such that the second process reads the first processing command from the shared memory region based on the information of the shared memory, and performs a processing operation based on the first processing command.

In some embodiments, the second process indicates a third-party component; the shared memory region includes a first shared memory region and a second shared memory region; the first shared memory region is configured to store data written by the first process, and the second shared memory region is configured to store data to be read by the first process.

The first communication module 840 is configured to:
write the first processing command into the first shared memory region such that the second process reads the first processing command from the first shared memory region, performs a corresponding processing operation based on the first processing command to obtain a first processing result, and writes the first processing result into the second shared memory region.

The first communication module 840 is further configured to:
read the first processing result from the second shared memory region and based on the first processing result, perform a corresponding processing operation.

In some embodiments, the first shared memory region corresponds to a first read semaphore and a first write semaphore.

The first communication module 840 is further configured to:
set the first write semaphore to a first state identifier and write the first processing command into the first shared memory region; where the first state identifier is configured to indicate that the first shared memory region is in a data write state;
in response to completing the writing of the first processing command, set the first write semaphore to a second state identifier, and set the first read semaphore to a third state identifier, such that the second process reads the first processing command from the first shared memory region in response to determining that the first read semaphore is set to the third state identifier, performs the corresponding processing operation based on the first processing command to generate the first processing result, and writes the first processing result into the second shared memory region; where the second state identifier indicates that the first shared memory region is in a data un-write state and the third state identifier indicates that the first shared memory is in a data read state.

In some embodiments, the first communication module 840 is further configured to:
write the first processing command into the first shared memory region and lock the first shared memory region;
in response to completing the writing of the first processing command, unlock the first shared memory region such that the second process reads the first processing command from the first shared memory region in response to determining that the first shared memory region is unlocked, performs the corresponding processing operation based on the first processing command to generate the first processing result, and writes the first processing result into the second shared memory region.

In some embodiments, the first processing command is in a first preset data format; the first processing result is generated based on a second preset data format; and a development language corresponding to the first process is different from a development language corresponding to the second process.

In some embodiments, the first process includes a play process and the second process includes a decoding process; the to-be-processed service request includes a video play request; the first processing command includes a video loading command; and the first processing result includes first indication information.

The request processing module 810 is further configured to:
based on the video play request, determine a video loading command identifier and a storage position of a to-be-played video;
based on a first preset data format, perform encapsulation on the video loading command identifier and the storage position of the to-be-played video to obtain the video loading command.

In some embodiments, the first communication module 840 is further configured to:
write the video loading command into the first shared memory region such that the second process, in response to the video loading command identifier in the video loading command, obtains the to-be-played video based on the storage position of the to-be-played video in the video loading command, analyzes the to-be-played video to obtain video information of the to-be-played video, creates a third shared memory region, performs encapsulation on information of the third shared memory region and the video information based on a second preset data format, and writes the first indication information obtained by encapsulation into the second shared memory region; where the third shared memory region is configured to store a decoded to-be-played video.

In some embodiments, the information of the third shared memory region includes a name of the third shared memory region.

The first communication module 840 is further configured to:
in response to determining that the first indication information is read from the second shared memory region, generate a video play command;
write the video play command into the first shared memory region; where the video play command is configured to indicate that the second process decodes the to-be-played video and writes the decoded to-be-played video into the third shared memory region;
based on the name of the third shared memory region, read the decoded to-be-played video from the third shared memory region and play the decoded to-be-played video.

In some embodiments, there is one or more to-be-played videos;
the request processing module 810 is further configured to:
in response to determining that the video play request indicates a plurality of to-be-played videos, create a plurality of shared memory regions, and determine a plurality of startup parameters; where the plurality of startup parameters are in one-to-one correspondence with the plurality of shared memory regions; and each of the plurality of startup parameters is configured to start up one second process.

In some embodiments, the information of the shared memory region includes a name and/or size of the shared memory region;
the request processing module 810 is further configured to:
in response to determining that the second process is in a non-running state, create the shared memory region and determine the startup parameter.

The request processing module is further configured to:
in response to determining that the second process is in a running state, generate the first processing command based on the to-be-processed service request.

In some embodiments, the first communication module 840 is further configured to:
write first heartbeat data into the shared memory region; where the first heartbeat data is configured to indicate that the second process generates a first response result based on the first heartbeat data and writes the first response result into the shared memory region;
in response to determining that the first response result is not read from the shared memory region within a first preset time, stop the second process and start up a new second process.

FIG. 9 is a block diagram illustrating another service processing apparatus according to an exemplary embodiment of the present disclosure, where the apparatus is applied to an electronic device. The electronic device is configured to perform the first process. The apparatus includes:
a process startup module 910, configured to obtain a startup parameter conveyed by a first process, and perform startup based on the startup parameter; where the startup parameter includes information of a shared memory region;
a second communication module 920, configured to, based on the information of the shared memory region, read a first processing command from the shared memory region; where the first processing command is generated by the first process in response to receiving a to-be-processed service request;
a service processing module 930, configured to perform a processing operation based on the first processing command.

In some embodiments, the shared memory region includes a first shared memory region and a second shared memory region;
the second communication module 920 is configured to:
read the first processing command from the first shared memory region.

The second communication module 920 is further configured to:
write a first processing result into the second shared memory region such that the first process reads the first processing result from the second shared memory region, and performs a corresponding processing operation based on the first processing result; where the first processing result is obtained by performing the processing operation based on the first processing command.

In some embodiments, the second shared memory region corresponds to a second read semaphore and a second write semaphore;
the second communication module 920 is further configured to:
set the second write semaphore to a fourth state identifier, and write the first processing result into the second shared memory region; where the fourth state identifier is configured to indicate that the second shared memory region is in a data write state;
in response to completing the writing of the first processing result, set the second write semaphore to a fifth state identifier and set the second read semaphore to a sixth state identifier, such that the first process reads the first processing result from the second shared memory region in response to determining that the second read semaphore is set to the sixth state identifier; where the fifth state identifier indicates that the second shared memory region is in a data un-write state and the sixth state identifier indicates that the second shared memory region is in a data read state.

In some embodiments, the second communication module 920 is further configured to:
write the first processing result into the second shared memory region and lock the second shared memory region;
in response to completing the writing of the first processing result, unlock the second shared memory region such that the first process reads the first processing result from the second shared memory region.

In some embodiments, the second process includes a decoding process, and the first process includes a play process; the first processing command includes a video loading command and the first processing result includes first indication information;
the second communication module 920 is further configured to:
based on a storage position of a to-be-played video in the video loading command, obtain the to-be-played video, and analyze the to-be-played video to obtain video information of the to-be-played video;
create a third shared memory region; where the third shared memory region is configured to store a decoded to-be-played video;
based on a second preset data format, perform encapsulation on information of the third shared memory region and the video information to obtain the first indication information.

The second communication module 920 is further configured to:
write the first indication information into the second shared memory region such that the first process generates a video play command based on the first indication information and writes the video play command into the first shared memory region.

In some embodiments, the information of the third shared memory region includes a name of the third shared memory region;
the second communication module 920 is further configured to:
in response to determining that the video play command is read from the first shared memory region, decode the to-be-played video;
write the decoded to-be-played video into the third shared memory region such that the first process reads the decoded to-be-played video from the third shared memory region based on the name of the third shared memory region, and plays the decoded to-be-played video.

In some embodiments, the second communication module 920 is further configured to:
write second heartbeat data into the shared memory region; where the second heartbeat data is configured to indicate that the first process generates a second response result based on the second heartbeat data and writes the second response result into the shared memory region;
in response to determining that the second response result is not read from the shared memory region within a second preset time, stop a running operation.

The implementation process of the functions and effects of each module in the above apparatus can be referred to the implementation process of the corresponding steps in the above methods and will not be repeated herein.

Correspondingly, the present disclosure further provides an electronic device, including a processor, and a memory storing processor executable instructions, where the processor is configured to:
in response to receiving a to-be-processed service request, create a shared memory region, and determine a startup parameter, where the startup parameter includes information of the shared memory region;
convey the startup parameter to a second process such that the second process is started up based on the startup parameter; where the second process indicates a functional module used to implement the to-be-processed service request;
based on the to-be-processed service request, generate a first processing command;
write the first processing command into the shared memory region such that the second process reads the first processing command from the shared memory region based on the information of the shared memory, and performs a processing operation based on the first processing command;
or,
obtain a startup parameter conveyed by the first process and perform startup based on the startup parameter, where the startup parameter includes information of a shared memory region;
based on the information of the shared memory region, read a first processing command from the shared memory region; where the first processing command is generated by the first process in response to receiving a to-be-processed service request;
based on the first processing command, perform a processing operation.

In another embodiment, the present disclosure further provides a computer readable storage medium, storing computer executable instructions, where the computer executable instructions are executed by a processor to perform the above service processing methods.

In another embodiment, the present disclosure further provides a computer program product, including a computer program, where the computer program is executed by a processor to perform the above service processing methods.

Since the apparatus embodiments substantially correspond to the method embodiments, a reference may be made to part of the descriptions of the method embodiments for the related part. The apparatus embodiments described above are merely illustrative, where the modules described as separate members may be or not be physically separated, and the members displayed as modules may be or not be physical modules, i.e., may be located in one place, or may be distributed to a plurality of network modules. Part or all of the modules may be selected according to actual requirements to implement the objectives of the solutions in the embodiments. Those of ordinary skill in the art may understand and carry out them without creative work.

The specific embodiments of the present disclosure are described as above. Other embodiments may also be obtained within the scope of the appended claims. In some cases, the actions or steps recorded in the claims may be performed in a sequence different from the embodiments to achieve the desired result. Further, the processes shown in drawings do not necessarily require a particular sequence or a continuous sequence to achieve the desired result. In some embodiments, a multi-task processing and parallel processing are possible and may also be advantageous.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and embodiments are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims. Furthermore, the data involved in the present disclosure may be data authorized by the users or by various parties.

The above are only the preferred embodiments of the present disclosure and shall not be used to limit the present disclosure. Any changes, equivalent substitutions and improvements or the like made within the spirit and principle of the present disclosure shall all be incorporated in the scope of protection of the present disclosure.

1. A method comprising:
in response to receiving a to-be-processed service request, creating a shared memory region, and determining a startup parameter, wherein the startup parameter comprises information of the shared memory region, and the to-be-processed service request indicates that a second process is to be invoked;
conveying the startup parameter to the second process such that the second process is started up based on the startup parameter;
based on the to-be-processed service request, generating a first processing command; and
writing the first processing command into the shared memory region such that the second process reads the first processing command from the shared memory region based on the information of the shared memory region and performs a processing operation based on the first processing command.

2. The method of claim 1, wherein the shared memory region comprises a first shared memory region and a second shared memory region; wherein the first shared memory region is configured to store data written by the first process, and the second shared memory region is configured to store data to be read by the first process;
wherein writing the first processing command into the shared memory region comprises:
writing the first processing command into the first shared memory region such that the second process reads the first processing command from the first shared memory region, performs a corresponding processing operation based on the first processing command to obtain a first processing result, and writes the first processing result into the second shared memory region;
the method further comprises:
reading the first processing result from the second shared memory region, and
based on the first processing result, performing a corresponding processing operation.

3. The method of claim 2, wherein the first shared memory region corresponds to a first read semaphore and a first write semaphore;
wherein writing the first processing command into the first shared memory region comprises:
setting the first write semaphore to a first state identifier and writing the first processing command into the first shared memory region; wherein the first state identifier indicates that the first shared memory region is in a data write state; and
in response to completing the writing of the first processing command, setting the first write semaphore to a second state identifier, and setting the first read semaphore to a third state identifier, such that the second process reads the first processing command from the first shared memory region in response to determining that the first read semaphore is set to the third state identifier, performs the corresponding processing operation based on the first processing command to generate the first processing result, and writes the first processing result into the second shared memory region; wherein the second state identifier indicates that the first shared memory region is in a data un-write state and the third state identifier indicates that the first shared memory region is in a data read state.

4. The method of claim 2, wherein writing the first processing command into the first shared memory region comprises:
writing the first processing command into the first shared memory region and locking the first shared memory region; and
in response to completing the writing of the first processing command, unlocking the first shared memory region such that the second process reads the first processing command from the first shared memory region in response to determining that the first shared memory region is unlocked, performs the corresponding processing operation based on the first processing command to generate the first processing result, and writes the first processing result into the second shared memory region.

5. The method of claim 2, wherein the first processing command is in a first preset data format; wherein the first processing result is generated based on a second preset data format; and wherein a development language corresponding to the first process is different from a development language corresponding to the second process.

6. The method of claim 2, wherein the first process comprises a play process and the second process comprises a decoding process; wherein the to-be-processed service request comprises a video play request; wherein the first processing command comprises a video loading command; and wherein the first processing result comprises first indication information;
wherein generating the first processing command comprises:
based on the video play request, determining a video loading command identifier and a storage position of a to-be-played video; and
based on a first preset data format, performing encapsulation on the video loading command identifier and the storage position of the to-be-played video to obtain the video loading command;
wherein writing the first processing command into the shared memory region comprises:
writing the video loading command into the first shared memory region such that the second process, in response to the video loading command identifier in the video loading command, obtains the to-be-played video based on the storage position of the to-be-played video in the video loading command, analyzes the to-be-played video to obtain video information of the to-be-played video, creates a third shared memory region, performs encapsulation on information of the third shared memory region and the video information based on a second preset data format, and writes the first indication information obtained by encapsulation into the second shared memory region;
wherein the third shared memory region is configured to store a decoded to-be-played video.

7. The method of claim 6, wherein the information of the third shared memory region comprises a name of the third shared memory region;
wherein the method further comprises:
in response to determining that the first indication information is read from the second shared memory region, generating a video play command;
writing the video play command into the first shared memory region; wherein the video play command is configured to indicate that the second process decodes the to-be-played video and writes the decoded to-be-played video into the third shared memory region; and
based on the name of the third shared memory region, reading the decoded to-be-played video from the third shared memory region and playing the decoded to-be-played video.

8. The method of claim 6,
wherein creating the shared memory region and determining the startup parameter comprise:
in response to determining that the video play request indicates a plurality of to-be-played videos, creating a plurality of shared memory regions, and determining a plurality of startup parameters;
wherein the plurality of startup parameters are in one-to-one correspondence with the plurality of shared memory regions; and
wherein each of the plurality of startup parameters is configured to start up one second process.

9. The method of claim 1, wherein the information of the shared memory region comprises a name and/or size of the shared memory region;
wherein creating the shared memory region and determining the startup parameter comprise:
in response to determining that the second process is in a non-running state, creating the shared memory region and determining the startup parameter;
wherein the method further comprises:
in response to determining that the second process is in a running state, generating the first processing command based on the to-be-processed service request.

10. The method of claim 1, further comprising:
writing first heartbeat data into the shared memory region; wherein the first heartbeat data is configured to indicate that the second process generates a first response result based on the first heartbeat data and writes the first response result into the shared memory region; and
in response to determining that the first response result is not read from the shared memory region within a first preset time, stopping the second process and starting up a new second process.

11. A method, comprising:
obtaining a startup parameter conveyed by a first process, and performing startup based on the startup parameter; wherein the startup parameter comprises information of a shared memory region;
based on the information of the shared memory region, reading a first processing command from the shared memory region; wherein the first processing command is generated by the first process in response to receiving a to-be-processed service request; and
based on the first processing command, performing a processing operation.

12. The method of claim 11, wherein the shared memory region comprises a first shared memory region and a second shared memory region;
wherein reading the first processing command from the shared memory region comprises:
reading the first processing command from the first shared memory region;
wherein the method further comprises:
writing a first processing result into the second shared memory region, such that the first process reads the first processing result from the second shared memory region, and performs a corresponding processing operation based on the first processing result; wherein the first processing result is obtained by performing the processing operation based on the first processing command.

13. The method of claim 12, wherein the second shared memory region corresponds to a second read semaphore and a second write semaphore;
wherein writing the first processing result into the second shared memory region comprises:
setting the second write semaphore to a fourth state identifier, and writing the first processing result into the second shared memory region; wherein the fourth state identifier is configured to indicate that the second shared memory region is in a data write state; and
in response to completing the writing of the first processing result, setting the second write semaphore to a fifth state identifier and setting the second read semaphore to a sixth state identifier, such that the first process reads the first processing result from the second shared memory region in response to determining that the second read semaphore is set to the sixth state identifier; wherein the fifth state identifier indicates that the second shared memory region is in a data un-write state and the sixth state identifier indicates that the second shared memory region is in a data read state.

14. The method of claim 12, wherein writing the first processing result into the second shared memory region comprises:
writing the first processing result into the second shared memory region and locking the second shared memory region; and
in response to completing the writing of the first processing result, unlocking the second shared memory region such that the first process reads the first processing result from the second shared memory region.

15. The method of claim 12, wherein the second process comprises a decoding process, and the first process comprises a play process; wherein the first processing command comprises a video loading command and the first processing result comprises first indication information;
wherein, based on the first processing command, performing the processing operation comprises:
based on a storage position of a to-be-played video in the video loading command, obtaining the to-be-played video, and analyzing the to-be-played video to obtain video information of the to-be-played video;
creating a third shared memory region; wherein the third shared memory region is configured to store a decoded to-be-played video; and
based on a second preset data format, performing encapsulation on information of the third shared memory region and the video information to obtain the first indication information;
wherein writing the first processing result into the second shared memory region comprises:
writing the first indication information into the second shared memory region such that the first process generates a video play command based on the first indication information and writes the video play command into the first shared memory region.

16. The method of claim 15, wherein the information of the third shared memory region comprises a name of the third shared memory region;
wherein the method further comprise:
in response to determining that the video play command is read from the first shared memory region, decoding the to-be-played video; and
writing the decoded to-be-played video into the third shared memory region such that the first process reads the decoded to-be-played video from the third shared memory region based on the name of the third shared memory region, and plays the decoded to-be-played video.

17. The method of claim 11, further comprising:
writing second heartbeat data into the shared memory region; wherein the second heartbeat data is configured to indicate that the first process generates a second response result based on the second heartbeat data and writes the second response result into the shared memory region; and
in response to determining that the second response result is not read from the shared memory region within a second preset time, stopping a running operation.

18-19. (canceled)

20. An electronic device, comprising a memory, a processor and a computer program stored in the memory and run on the processor, wherein the processor executes the computer program to perform the service processing method of claim 1.

21. A non-transitory computer readable storage medium, storing computer executable instructions, wherein the computer executable instructions are executed by a processor to perform the service processing method of claim 1.
